(19) United States
(12) Patent Application Publication
(10) Pub. No.: US 2011/0079946 A1
(43) Pub. Date: Apr. 7, 2011

(54) Apparatus for Connecting Two Vises to Each Other

(76) Inventor: Ching-Chen YANG, Taichung City (TW)

(21) Appl. No.: 12/573,071

(22) Filed: Oct. 2, 2009

(51) Int. Cl. B25B 1/24

(52) U.S. Cl. 269/88

(57) ABSTRACT

An apparatus is disclosed for connecting a bar of a vise to a bar of another vise. The apparatus includes a sheath and two fastening units. The sheath includes two cavities each axially defined in an end thereof and two apertures defined therein transversely and each in communication with a related one of the cavities. Each of the fastening units can be inserted in a related one of the apertures of the sheath and an aperture defined in the bar of a related one of the vises, thus connecting the bars to each other.

### BACKGROUND OF INVENTION

1. Field of Invention

The present invention relates to a vise and, more particularly, to an apparatus for connecting two vises to each other.

2. Related Prior Art

Referring to FIG. 1, a conventional vise 1 includes a bar 2, a handle 4 operable to move the bar 2 relative thereto, a first jaw formed on the handle and a second jaw 3 secured to the bar 2. To encompass an object, the second jaw 3 is moved away from the first jaw by operating the handle 4. The clamp the object, the second jaw 3 is moved towards the first jaw by operating the handle 4. The largest distance between the first and second jaws is determined by the length of the bar 2. An object might be too big for the vise 1 since the bar 2 is not long enough. In such a case, a longer bar is needed. It is however inconvenient to bring an additional long bar together with a jaw.

The present invention is therefore intended to obviate or at least alleviate the problems encountered in prior art.

### SUMMARY OF INVENTION

It is the primary objective of the present invention to provide an apparatus for connecting two vises to each other to clamp a large object.

To achieve the foregoing objective, the apparatus includes a sheath and two fastening units. The sheath includes two cavities each axially defined in an end thereof and two apertures defined therein transversely and each in communication with a related one of the cavities. Each of the fastening units can be inserted in a related one of the apertures of the sheath and an aperture defined in the bar of a related one of the vises, thus connecting the bars to each other.

Other objectives, advantages and features of the present invention will become apparent from the following description referring to the attached drawings.

### BRIEF DESCRIPTION OF DRAWINGS

The present invention will be described via detailed illustration of the preferred embodiment versus the prior art referring to the drawings.

FIG. 1 is a side view of a conventional vise.

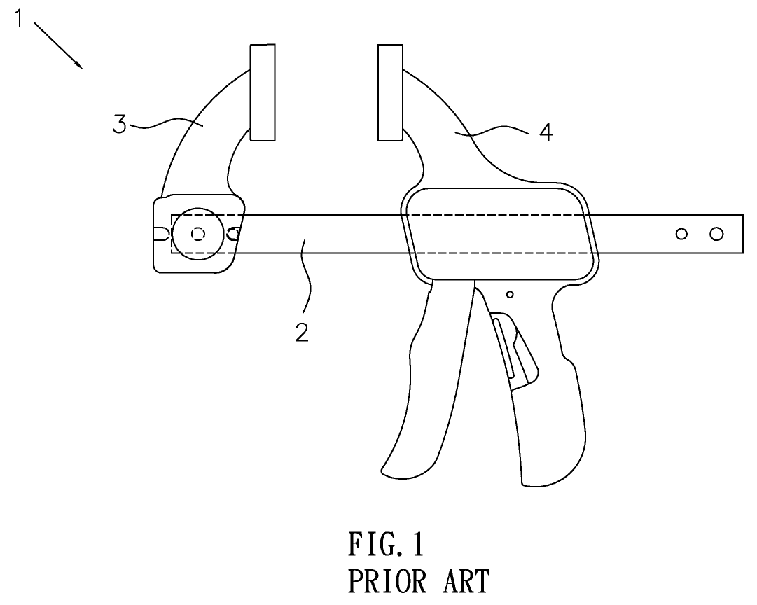

FIG. 2 is an exploded view of a connector according to the preferred embodiment of the present invention.

FIG. 3 is an exploded view of two vises connected to each other via the connector shown in FIG. 2.

FIG. 4 is a cross-sectional view of the connector shown in FIG. 3.

FIG. 5 is another cross-sectional view of the connector of FIG. 4.

FIG. 6 is an exploded view of the connector and the vises shown in FIG. 3.

FIG. 7 is an exploded view of the connector and the vises in another position than shown in FIG. 6.

### DETAILED DESCRIPTION OF PREFERRED EMBODIMENT

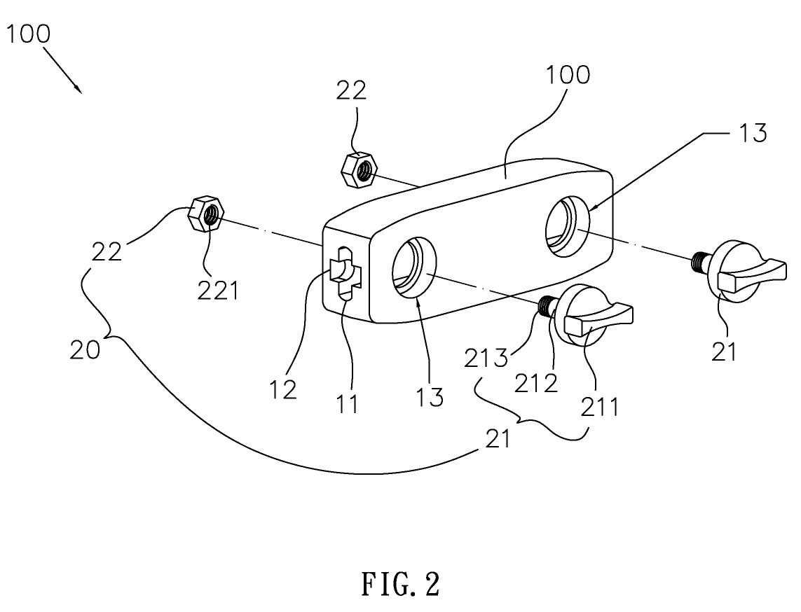

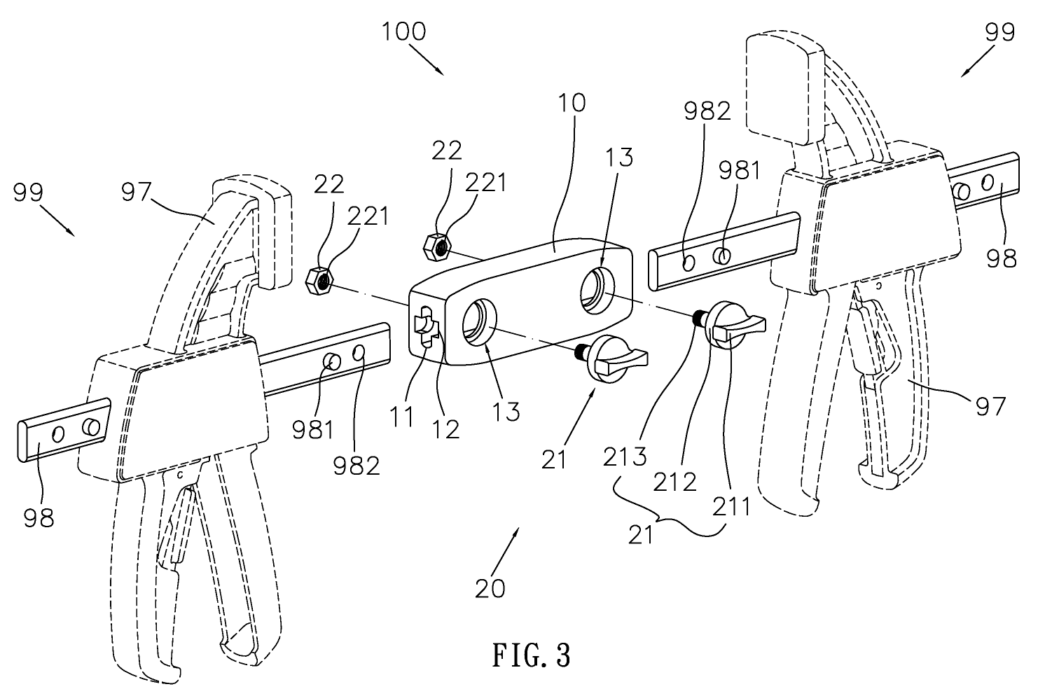

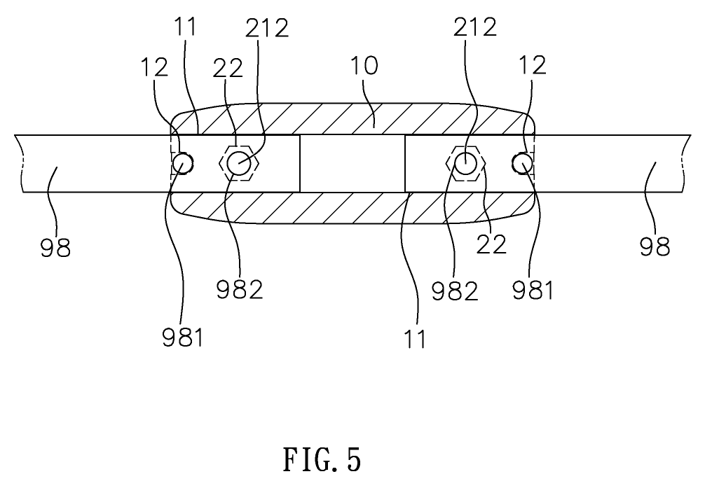

Referring to FIGS. 2 through 5, there is shown an apparatus 100 for connecting two vises 99 to each other according to the preferred embodiment of the present invention. Each of the vise 99 includes a bar 98, a handle 97 operable to move the bar 98 relative thereto, a first jaw formed on the handle 97 and a second jaw (not shown) detachably connected to the bar 98. The bar 98 includes two bosses 981 each formed on a side thereof and an aperture 982 transversely defined therein. The apparatus 100 includes a sheath 10 and two fastening units 20. The sheath 10 includes two cavities 11, two pair of grooves 12 and two apertures 13. Each of the cavities 11 is axially defined in an end of the sheath 10. The cavities 11 can be in communication with or separated from each other. Each of the pairs of grooves 12 is in communication with a related one of the cavities 11. The apertures 13 are transversely defined in the sheath 10. Each of the apertures 13 is in communication with a related one of the cavities 11.

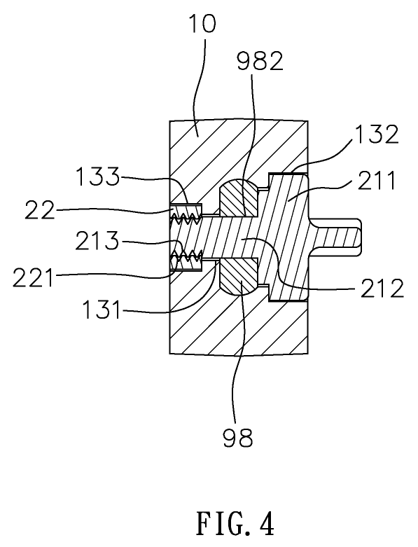

As clearly shown in FIG. 4, each of the apertures 13 includes a middle section 131 between a first terminal section 132 and a second terminal section 133. The middle section 131 includes a circular cross-sectional shape. The first terminal section 132 includes a circular cross-sectional shape, too. The diameter of the middle section 131 is smaller than that of the first terminal section 132. The second terminal section 133 includes a hexagonal cross-sectional shape. The diameter of the middle section 131 is smaller than the length of a diagonal line of the second terminal section 133.

Each of the fastening units 20 includes a knob/screw 21 and a nut 22. The knob/screw 21 includes a knob 211 and a screw 212. The screw 212 includes an end secured to the knob 211 and another end formed with a thread 213. The diameter of the screw 212 is marginally smaller than the diameter of the middle section 131 of each of the apertures 13. The diameter of the knob 211 is marginally smaller than the diameter of the first terminal section 132 of each of the apertures 13.

Each of the nut 22 includes a thread 221 formed on an internal side thereof. The length of a diagonal line of the nut 22 is marginally smaller than the length of the diagonal line of the second terminal section 133 of each of the apertures 13.

The bar 98 of each of the vises 99 is inserted in a related one of the cavities 11 of the sheath 10. The bosses 981 of the bar 98 of each of the vises 99 are located in a related pair of grooves 12. The aperture 982 of the bar 98 each of the vises 99 is aligned with a related one of the apertures 13 of the sheath 10. Each of the screws 212 is inserted through the middle section 131 of a related one of the apertures 13. Each of the knobs 211 is located in the first terminal section 132 of a related one of the apertures 13. Each of the nuts 22 is located in the second terminal section 133 of a related one of the apertures 13. The thread 213 of each of the screws 212 is engaged with the thread 221 of a related one of the nuts 22.

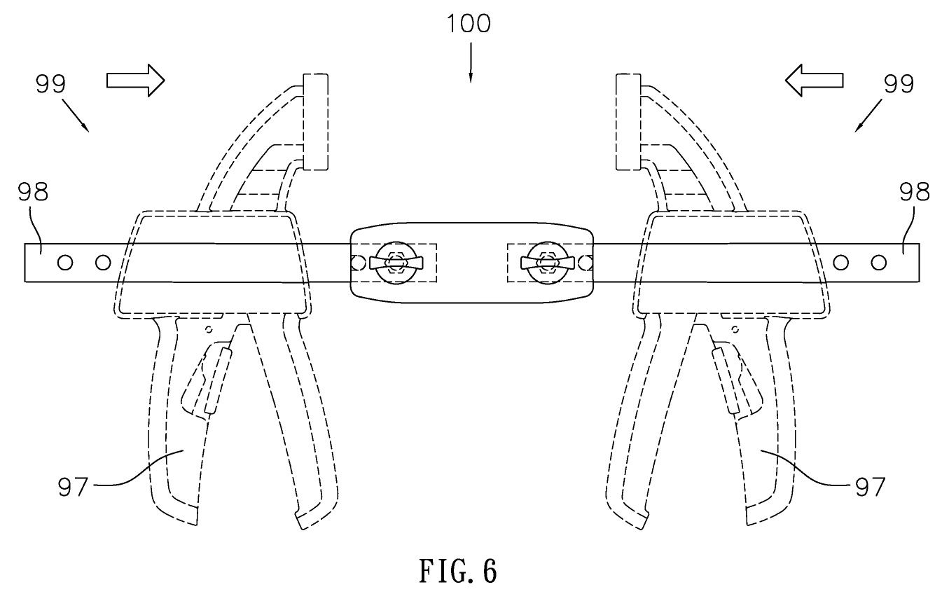

Referring to FIG. 6, the bars 98 are connected to each other via the apparatus 100 and together become a longer bar. The handles 97 are connected to the joined bars 98 in a manner. The handle 97 of at least one of the vises 99 is operated to move the first jaws of the vises 99 towards each other for clamping a large object.

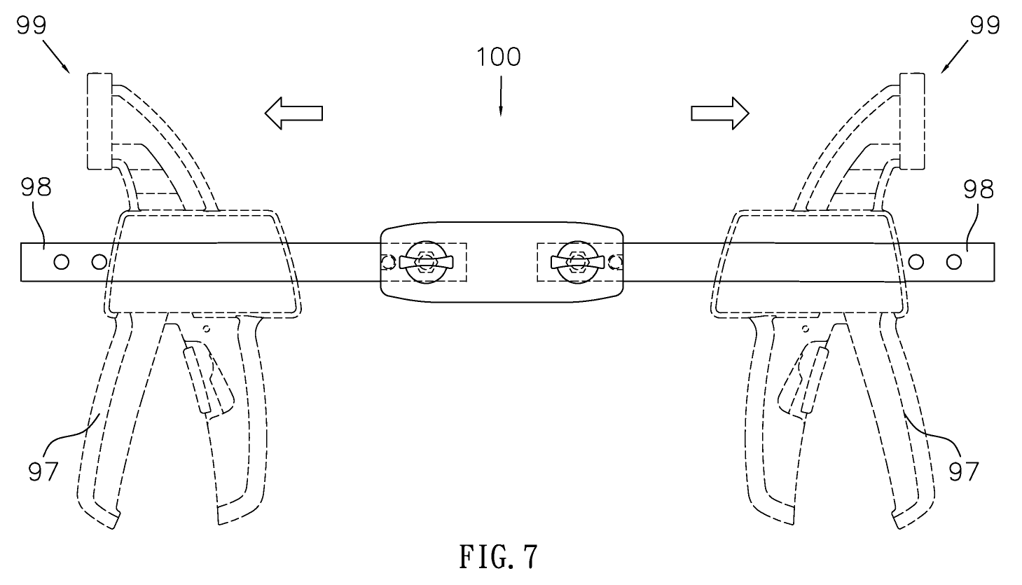

Referring to FIG. 7, the bars 98 are connected to each other via the apparatus 100 and together become a longer bar. The handles 97 are connected to the joined bars 98 in another manner. The handle 97 of at least one of the vises 99 is operated to move the first jaws of the vises 99 away from each other for pushing two objects away from each other.

Advantageously, the bars 98 of two vises 99 can be connected to each other via the apparatus 100 and together become a longer bar. Thus, the vises 99 can be used together to clamp a large object or push two objects away from each other without having to use a long bar.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An apparatus for connecting a bar of a vise to a bar of another vise, the apparatus comprising:
a sheath comprising two cavities each axially defined in an end thereof and two apertures defined therein transversely and each in communication with a related one of the cavities; and
two fastening units each for insertion in a related one of the apertures of the sheath and an aperture defined in the bar of a related one of the vises, thus connecting the bars to each other.

2. The apparatus according to claim 1, wherein each of the fastening units comprises a screw inserted through the related aperture and a nut engaged with the screw.

3. The apparatus according to claim 2, wherein each of the apertures of the sheath comprises a first section for receiving a head of the screw, a second section for receiving the nut and a middle section through which the screw is inserted.

4. The apparatus according to claim 3, wherein the nuts comprise a hexagonal cross-sectional shape, and the second terminal section of each of the apertures comprises a hexagonal cross-sectional shape corresponding to the nuts.

5. The apparatus according to claim 2, wherein each of the fastening units comprises a knob secured to a head of the screw.
